(19) United States
(12) Patent Application Publication
(10) Pub. No.: US 2026/0065884 A1
(43) Pub. Date: Mar. 5, 2026

(54) INFORMATION PROCESSING APPARATUS, ELECTRONIC MUSICAL INSTRUMENT, METHOD, AND RECORDING MEDIUM

(71) Applicant: CASIO COMPUTER CO., LTD., Tokyo (JP)

(72) Inventor: Daisuke OKIZAWA, Tokyo (JP)

(73) Assignee: CASIO COMPUTER CO., LTD., Tokyo (JP)

(21) Appl. No.: 19/316,581

(22) Filed: Sep. 2, 2025

(30) Foreign Application Priority Data
Sep. 2, 2024 (JP) 2024-150417

(51) Int. Cl. G10H 1/00

(52) U.S. Cl. CPC G10H 1/0025

(57) ABSTRACT

An information processing apparatus includes: at least one performance operation element to which a performance pattern among a plurality of performance operation elements is assigned; and at least one processor. The at least one processor: sets a tempo of the performance pattern on a basis of a timing of a plurality of operations on the performance operation element, and plays a musical sound of the performance pattern at the tempo having been set.

### CROSS-REFERENCE TO RELATED APPLICATIONS

This application claims priority based on Japanese Patent Application No. 2024-150417 filed in Japan on September 2, 2024, the entire contents of which are incorporated herein.

### TECHNICAL FIELD

The present disclosure relates to an information processing apparatus, an electronic musical instrument, method, and a recording medium.

### BACKGROUND

Electronic musical instruments that perform automatic performance are known. A specific configuration of this type of electronic musical instrument is described in, for example, JP 2000-194371 A. When receiving a predetermined user operation, the electronic musical instrument described in this publication switches an accompaniment pattern, for example, and automatically plays an accompaniment with the switched accompaniment pattern.

### SUMMARY

An information processing apparatus according to an embodiment of the present disclosure includes: at least one performance operation element to which a performance pattern among a plurality of performance operation elements is assigned; and at least one processor. The at least one processor: sets a tempo of the performance pattern on a basis of a timing of a plurality of operations on the performance operation element, and plays a musical sound of the performance pattern at the tempo having been set.

### BRIEF DESCRIPTION OF THE DRAWINGS

FIG. 1 is an external view of an electronic musical instrument according to an embodiment of the present disclosure;

FIG. 2 is a block diagram illustrating a configuration of the electronic musical instrument according to an embodiment of the present disclosure;

FIG. 3 is a diagram illustrating an example of a performance pattern assigned to a keyboard of an electronic musical instrument according to an embodiment of the present disclosure;

FIG. 4 is a diagram for describing a method of setting a tempo of a performance pattern according to an embodiment of the present disclosure;

FIG. 5 is a flowchart illustrating processing executed by the electronic musical instrument in an embodiment of the present disclosure;

FIG. 6 is a flowchart illustrating processing executed by the electronic musical instrument in a first modification of the present disclosure; and

FIG. 7 is a diagram illustrating a method of setting a tempo of a performance pattern in a second modification of the present disclosure.

### DETAILED DESCRIPTION

The following description relates to an information processing apparatus, an electronic musical instrument, a method, and a program according to an embodiment of the present disclosure. Common or corresponding elements are denoted by the same or similar reference signs, and redundant description is appropriately simplified or omitted.

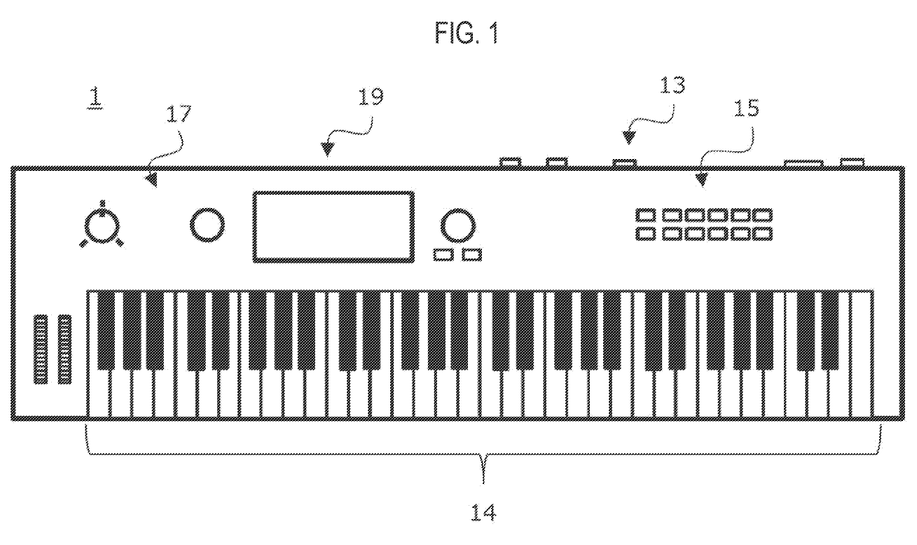

An electronic musical instrument 1 illustrated in FIG. 1 is an example of an information processing apparatus and an example of a performance apparatus. The electronic musical instrument 1 is, for example, an electronic keyboard. The electronic musical instrument 1 may be an electronic keyboard instrument other than an electronic keyboard, such as an electronic piano. The electronic musical instrument 1 may be another form of electronic musical instrument such as an electronic percussion instrument, an electronic wind instrument, or an electronic string instrument.

The information processing apparatus of the present disclosure is not limited to the electronic musical instrument 1. The information processing apparatus may be, for example, an apparatus in which a musical instrument application for reproducing the electronic musical instrument 1 is installed. Exemplarily, the information processing apparatus may be a smartphone, a tablet terminal, a laptop personal computer (PC), a portable game machine, or a personal digital assistant (PDA) in which such a musical instrument application is installed.

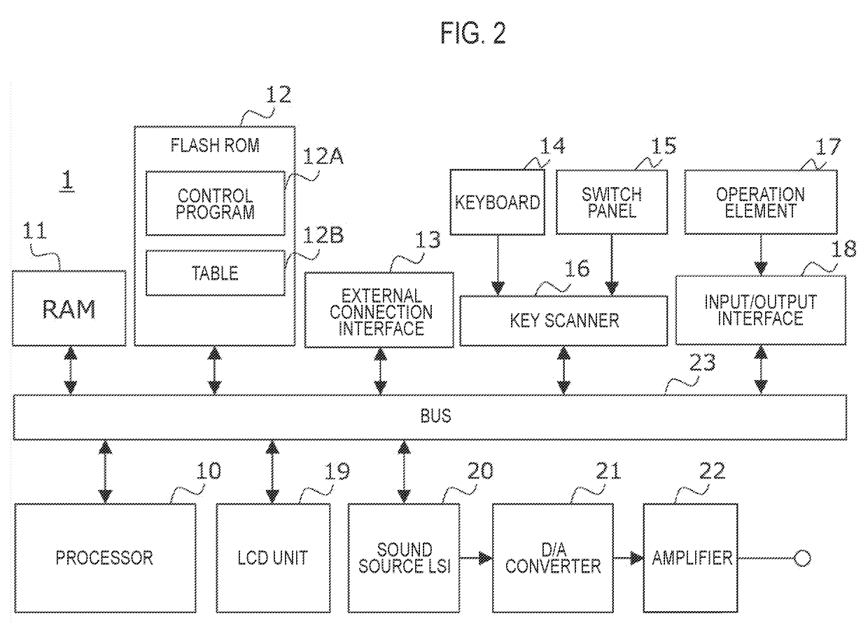

The electronic musical instrument 1 is an example of a computer. As illustrated in FIG. 2, the electronic musical instrument 1 includes, as a hardware configuration, a processor 10, a random access memory (RAM) 11, a flash read only memory (ROM) 12, an external connection interface 13, a keyboard 14, a switch panel 15, a key scanner 16, an operation element 17, an input/output interface 18, a liquid crystal display (LCD) unit 19, a sound source large scale integration (LSI) 20, a D/A converter 21, and an amplifier 22. Each unit of the electronic musical instrument 1 is connected by a bus 23.

The processor 10 reads a program and data stored in the flash ROM 12. The processor 10 integrally controls the electronic musical instrument 1 by using the RAM 11 as a work area.

The processor 10 is, for example, a single processor or a multiprocessor, and includes at least one processor. In the case of a configuration including a plurality of processors, the processor 10 may be packaged as a single device, or may be configured by a plurality of devices physically separated in the electronic musical instrument 1. The processor 10 may be referred to as, for example, a controller, a central processing unit (CPU), a micro processor unit (MPU), or a micro controller unit (MCU).

The RAM 11 temporarily holds data and a program. The RAM 11 holds various programs and various data read from the flash ROM 12.

The flash ROM 12 is a nonvolatile semiconductor memory such as a flash memory, an erasable programmable ROM (EPROM), or an electrically erasable programmable ROM (EEPROM). The flash ROM 12 stores a control program 12A. When the processor 10 executes the control program 12A, various processing according to an embodiment of the present disclosure is executed.

The external connection interface 13 is, for example, an interface that inputs and outputs musical instrument digital interface (MIDI) data (MIDI message) to and from an external MIDI device in a serial format under the control of the processor 10.

The keyboard 14 includes 61 keys that are performance operation elements. Specifically, the keyboard 14 includes 32 white keys and 25 black keys. Each key is associated with a different pitch. The electronic musical instrument 1 produces musical sound in response to a key pressing operation on a key included in the keyboard 14. The number of keys of the keyboard 14 is not limited to 61. The keyboard 14 may include another number of keys such as 88 keys and 76 keys. That is, each key of the keyboard 14 is an example of a plurality of performance operation elements that designates different pitches.

The switch panel 15 includes various operation elements for operating the electronic musical instrument 1. The various operation elements include operation elements corresponding to various functions such as power supply, recording, play/stop, tone adjustment, and timbre selection.

The key scanner 16 monitors key pressing and key release on the keyboard 14. For example, when detecting a key pressing operation performed by a user, the key scanner 16 outputs a key pressing event to the processor 10. The key pressing event includes information (key number) regarding a pitch of a key related to the key pressing operation. The key number may also be referred to as a key number, a MIDI key, or a note number. The pitch is sometimes called a note.

In the present embodiment, means for measuring a key pressing velocity (velocity) is separately provided, and the velocity measured by the means is also included in the key pressing event. Exemplarily, a plurality of contact switches is provided for each key. The velocity is measured by a difference in time at which each contact switch is electrically connected when the key is pressed. The velocity can also be said to be a value indicating a strength of the key pressing operation or a value indicating a loudness (volume) of the musical sound.

The operation element 17 includes a rotary encoder for parameter selection, a rotary encoder for parameter value input, a pitch bender wheel, a modulation wheel, and the like. When the user operates the operation element 17, a signal indicating the operation content is output to the processor 10 via the input/output interface 18.

The LCD unit 19 includes an LCD and a driver. When the driver drives the LCD in accordance with a control signal from the processor 10, a screen corresponding to the control signal is displayed. The LCD may be replaced with a display device in another form such as an organic electro luminescence (EL).

The sound source LSI 20 includes a media player and a sound source module. The media player incorporates a codec corresponding to various formats. The media player can play audio data in various formats. The sound source module processes various events (note-on, auto-off, control change, and the like) corresponding to a performance operation. For example, when a note-on event corresponding to a key pressing operation is input, the sound source module reads corresponding waveform data in accordance with a sound production instruction from the processor 10. The waveform data is stored in, for example, the flash ROM 12. The waveform data is loaded into the RAM 11 at the time of activation processing for the electronic musical instrument 1 so that a musical sound is promptly produced in response to a key pressing operation.

The sound source module generates a musical sound on the basis of the waveform data read from the RAM 11. The sound source module includes a plurality of generator sections. The sound source module can simultaneously produce up to the same number of musical sounds as the number of the generator sections. In the present embodiment, the processor 10 and the sound source LSI 20 are configured as separate processors, but in another embodiment, the processor 10 and the sound source LSI 20 may be configured as one processor.

Digital musical sound data generated by the sound source LSI 20 is converted into an analog signal by the D/A converter 21, then amplified by the amplifier 22, and output from a line-out terminal, for example. For example, a musical sound is played by a speaker connected to the line-out terminal. The speaker may be built in or externally connected to the electronic musical instrument 1.

In an electronic musical instrument such as an electronic keyboard or a drum pad, a single tone or a phrase of a drum (an example of a percussion instrument) can be assigned to a performance operation element (key, pad). However, in a case of an electronic musical instrument to which a single tone is assigned, it is difficult to reproduce a realistic drum performance unless a person knows a phrase of drums and can play a plurality of musical instruments such as a bass drum, a snare drum, a tom-tom, and a cymbal by dexterously moving fingers of both hands. On the other hand, in a case of the electronic musical instrument to which the phrase of drums is assigned, the user can easily play even a complicated phrase by pressing the performance operation element. However, the operation of pressing the performance operation element only switches the phrase. Since a feeling of mechanical operation is strong and the number of ways of operating is small, it is difficult for the user to obtain a feeling of realistically playing the drums. An electronic musical instrument includes a first mode in which only one timbre sounds for each performance operation element; and a second mode in which a timbre which is different from the timbre of the first mode sounds as the performance pattern.

Therefore, in the electronic musical instrument 1 according to the present embodiment, performance patterns of different drums are assigned to individual keys (an example of a performance operation element) of the keyboard 14, a tempo of the performance pattern is set on the basis of timings of a plurality of key depression operations on the keys, and a musical sound of the performance pattern corresponding to each key pressing operation is played at the set tempo. That is, in the present embodiment, the performance pattern proceeds not at a preset constant tempo but at a tempo set in accordance with the key pressing operation.

For example, the user can reproduce musical instrument performance of drums and the like at a tempo (hereinafter referred to as an “operation tempo”) corresponding to a key pressing operation by performing a key pressing operation in accordance with a melody (built-in music of the electronic musical instrument 1, music played by another audio device, real performance of another person, and the like) to be played at the same time. Since the operation tempo corresponding to the melody is reflected as the tempo of the performance pattern, the user can obtain the feeling of realistically playing the musical instrument.

For example, it is not difficult for a user or a beginner who is not accustomed to playing a musical instrument to tap an appropriate key with a feeling of clapping in accordance with a melody in quadruple time. Every time the user taps a key, a musical sound of a performance pattern which is a short performance pattern (for example, a length of about one beat or two beats) assigned to the tapped key and in which taps such as a bass drum, a snare drum, and a cymbal are combined is played. The user can easily reproduce drum performance with good rhythm by tapping the key in accordance with the melody.

For example, in a case where the operation tempo of tapping the key is shifted from the melody, the musical sound of the performance pattern is played not in accordance with the melody but in accordance with the operation tempo. That is, even in such a case, the operation tempo is faithfully reflected as the tempo of the performance pattern. Therefore, the user can obtain a feeling of realistically performing drum performance.

The timbre of the musical sound constituting the performance pattern is a percussion instrument, and is drums (bass drum, snare drum, tom-tom, cymbal, and the like) in the present embodiment. This type of musical instrument is mainly a musical instrument that keeps rhythm, and there is no need to consider a chord. Therefore, the user can perform a performance in harmony with the melody only by appropriately tapping the key. The timbre of the musical sound constituting the performance pattern is not limited to the drums, and may be another musical instrument (percussion instrument such as, for example, tambourine, maracas, triangle, and the like).

In the present embodiment, a musical sound of a performance pattern in which a plurality of parts such as a bass drum, a snare drum, and a cymbal are combined is played. Therefore, even in a case where the user does not know the phrase of the drums, the user can reproduce natural drum performance without feeling strange. Since the performance pattern includes a plurality of parts (in other words, a plurality of timbres), the user can reproduce a wide variety of drum performances, and can also reproduce drum performances with high difficulty.

Each key of the keyboard 14 has a function of designating a performance pattern, a function as a trigger of starting playing of the performance pattern, and a function of setting a tempo of the performance pattern. In other words, the user can cause the electronic musical instrument 1 to execute various processing of specifying a performance pattern, playing the specified performance pattern, and setting a tempo of the performance pattern to be played only by performing a key pressing operation.

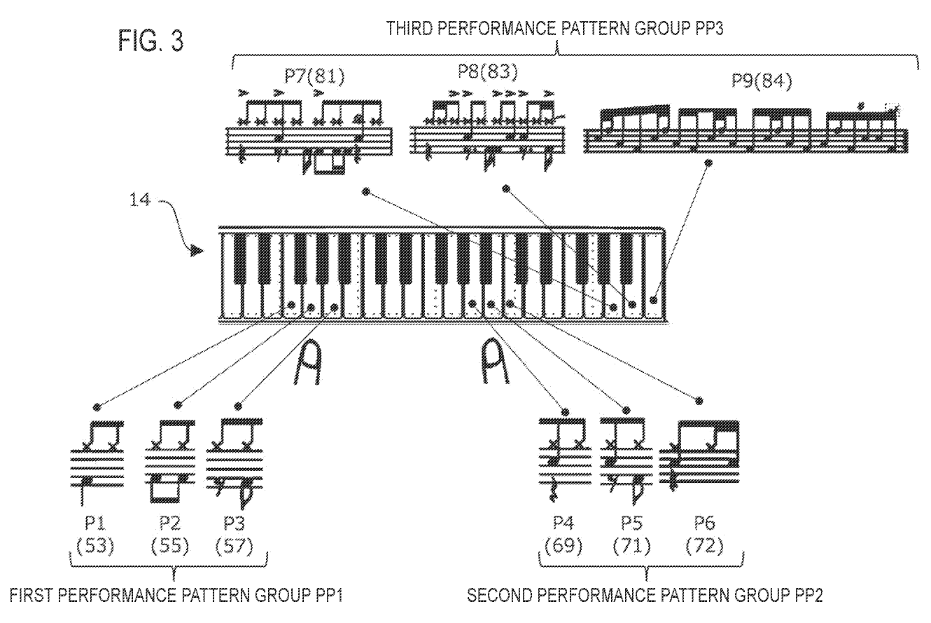

An example of the performance pattern assigned to each key of the keyboard 14 will be described with reference to FIG. 3. FIG. 3 illustrates some performance patterns assigned to individual keys of the keyboard 14. The performance pattern may be assigned to all the keys of the keyboard 14, or may be assigned to only some of the keys of the keyboard 14. Information indicating the key to which the performance pattern is assigned may be printed on a housing of the electronic musical instrument 1.

As illustrated in FIG. 3, a first performance pattern group PP1, a second performance pattern group PP2, and a third performance pattern group PP3 are assigned to the keyboard 14. Reference signs P1 to P9 denote performance patterns assigned to individual keys of the keyboard 14. Each number in parentheses following the reference signs P1 to P9 indicates a key number of the key to which the performance pattern is assigned. For example, the performance pattern P1 is assigned to the key of the key number 53 (=F3).

The correspondence relationship between the performance pattern and the key (in other words, the key number) is registered in a table 12B stored in the flash ROM 12. Note that the assignment of the performance pattern to the key is set in advance at a manufacturing stage of the electronic musical instrument 1. This assignment may be arbitrarily changed by a user operation.

A performance pattern created by the user or a performance pattern imported from an external device may be assigned to an arbitrary key. For example, the user can create a MIDI performance pattern or a pulse code modulation (PCM) performance pattern and assign the performance pattern to an arbitrary key. The user can also create minus-one data leaving only the drum part from the sound source and assign the minus-one data to an arbitrary key. The user can reproduce a richer variety of drum performances, and can easily reproduce a phrase that the user likes.

In the example of FIG. 3, the performance patterns P1 to P3 (that is, the first performance pattern group PP1), which are highly likely to be selected by the user for the first and third beats in a song in quadruple time, are assigned to the keys on the left side of the keyboard 14. The performance patterns P4 to P6 (that is, the second performance pattern group PP2), which are highly likely to be selected by the user for the second and fourth beats in a song in quadruple time, are assigned to the keys on the right side of the keyboard 14. Therefore, the user can experience simulated drum performance by an operation simulating a hitting operation using drum sticks, such as alternately hitting a key with the left finger and the right finger.

The performance patterns P1 to P6 include at least one musical sound and have a length of one or more beats (for example, length of one beat or two beats). The performance patterns P1 to P3 are, for example, performance patterns that do not include a snare drum. The performance patterns P4 to P6 are, for example, performance patterns that include a snare drum. The performance patterns P1 to P6 are, for example, portions of a phrase (an example of a predetermined phrase) such as a standard fill-in or beat that is often used in general. Examples of the standard phrase include a phrase in which the first, second, third, and fourth beats are constituted by the performance patterns P1, P4, P2, and P4, respectively, a phrase in which the first, second, third, and fourth beats are constituted by the performance patterns P1, P5, P1, and P4, respectively, and a phrase in which the first, second, third, and fourth beats are constituted by the performance patterns P1, P6, P3, and P4, respectively. Such a phrase is divided into a plurality of sections (for example, a section of one beat or two beats), and a phrase constituting musical sound (an example of at least one musical sound) proceeding in each divided section forms each of the performance patterns P1 to P6. For example, the user can easily reproduce a phrase of drums such as a standard fill-in or beat with an arrangement by appropriately tapping the key in accordance with the melody. For example, the user can easily reproduce a standard phrase such as eight beats by repeatedly tapping the same key.

The performance patterns P7 to P9 included in the third performance pattern group PP3 are difficult phrases having a length of about one to two measures that can be directly used as fill-in. Even a user or a beginner who is not accustomed to drum performance can easily enjoy performance requiring an advanced technique only by tapping the key to which the performance patterns P9 to P9 are assigned.

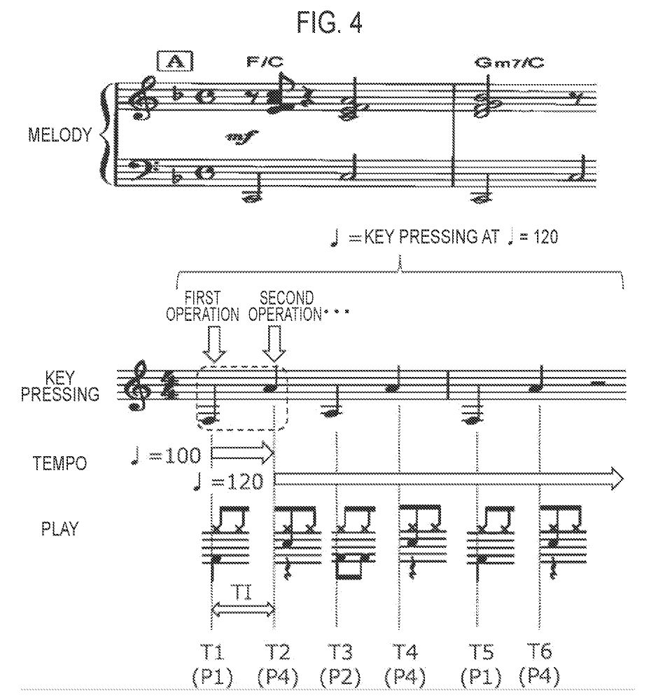

A method of setting the tempo of drum performance will be described with reference to FIG. 4. FIG. 4 illustrates a state in which the user performs a key pressing operation in accordance with a melody by using a musical score. In FIG. 4, a musical score to which a “melody” is added indicates a melody (built-in music of the electronic musical instrument 1, music played by another audio device, real performance of another person, and the like) that is played at the same time. In FIG. 4, the musical score to which “key pressing” is added indicates the timing of the key pressing operation by the user and the pitch of the corresponding key number. In the example of FIG. 4, the key pressing operation is performed at a tempo at which beats per minute (BPM) is 120. In FIG. 4, the “tempo” indicates a tempo of the performance pattern set on the basis of the timing of the key pressing operation. In FIG. 4, “play” indicates a musical sound of a performance pattern played in response to a key pressing operation by using a staff.

In FIG. 4, T1 to T6 indicate timings of the key pressing operation. The bracketed reference signs following the reference signs T1 to T6 indicate the performance pattern assigned to the pressed key. For example, at a timing T1, the key to which the performance pattern P1 is assigned is pressed.

The electronic musical instrument 1 sets the tempo of the performance pattern on the basis of a time interval TI between the timing T1 of the first key pressing operation (an example of a first operation) and a timing T2 of the second key pressing operation (an example of a second operation). In the example of FIG. 4, the time interval TI between the timing T1 and the timing T2 is five seconds. The electronic musical instrument 1 sets the time interval TI to a length of the quarter note, and sets the tempo of the performance pattern to a value corresponding to the time interval TI, that is, 120. Note that the time interval TI cannot be measured only by the first key pressing operation. Therefore, the performance pattern P1 corresponding to the first key pressing operation is played at a default tempo. The default tempo is, for example, 100.

As illustrated in each performance pattern to which “play” is added in FIG. 4, the user can make a musical sound of a performance pattern in which beat sounds such as a bass drum, a snare drum, and a cymbal are combined by only appropriately tapping a key in accordance with a melody, and can obtain a feeling of realistically playing complicated drum performance.

Since it is not necessary to set the tempo in advance, there are few restrictions on a timing of starting playing of the performance pattern. When the key pressing operation is performed, the musical sound of the corresponding performance pattern is quickly played. Therefore, the user can easily obtain a feeling of realistically performing drum performance.

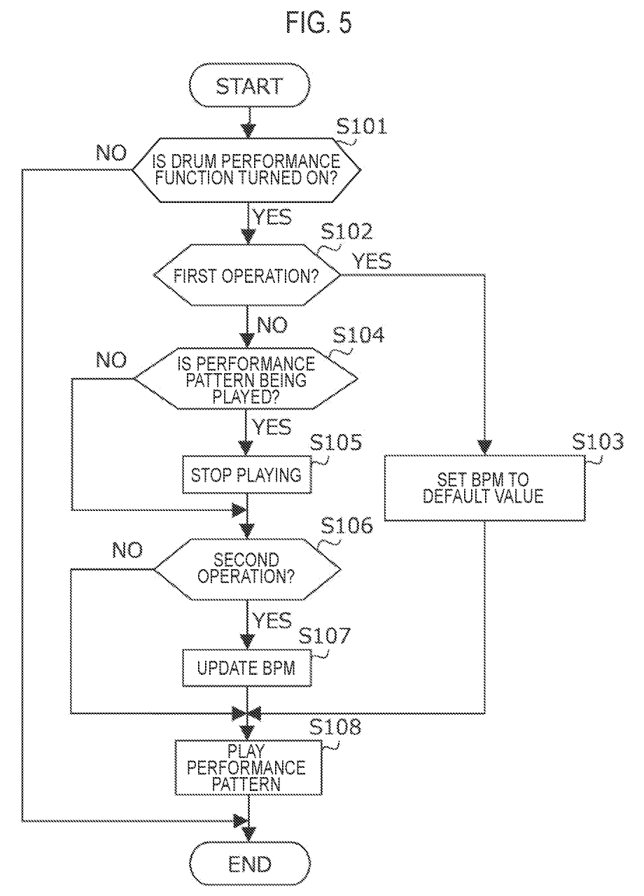

Processing executed by the electronic musical instrument 1 (specifically, the processor 10 and the sound source LSI 20) in an embodiment of the present disclosure will be described with reference to FIG. 5. For example, when the key pressing operation is performed on the keyboard 14, execution of the processing illustrated in FIG. 5 is started.

Note that order of each step of the flowchart indicated in the present embodiment may be changed within a range without inconsistency. For example, in the embodiment of the present disclosure, the processing including various Steps is presented using exemplary order, but the present embodiment is not limited to this presented order. Furthermore, the steps of the flowchart indicated in the present embodiment may be executed in parallel within a range without inconsistency.

The electronic musical instrument 1 determines whether a drum performance function (a second mode) is turned on (step S101). The drum performance function is a function of playing a musical sound of a performance pattern of drums in response to a key pressing operation. The user can turn on and off the drum performance function by operating the switch panel 15, for example. When the drum performance function is turned off (step S101: NO), the electronic musical instrument 1 ends the processing of this flowchart. In this case, the electronic musical instrument 1 performs, for example, normal sound production processing according to the key pressing event.

When the drum performance function is turned on (step S101: YES), the electronic musical instrument 1 determines whether a key pressing operation that has triggered a start of execution of the processing of FIG. 5 (hereinafter simply referred to as a “key pressing operation” in the description of FIG. 5) corresponds to the first operation (step S102). The first operation is, for example, a key pressing operation performed for the first time after the drum performance function is turned on (that is, the first key pressing operation).

In a case where the key pressing operation corresponds to the first operation (step S102: YES), the electronic musical instrument 1 sets the BPM of the performance pattern to a default value (for example, 100) (step S103). The electronic musical instrument 1 plays the musical sound of the performance pattern corresponding to the key pressing operation with the set default value of BPM (step S108). The electronic musical instrument 1 may change the volume of the performance pattern in accordance with the velocity at the time of the key pressing operation.

In a percussion instrument, when a percussion sound is made during the generation of the percussion sound, the generated percussion sound disappears, and a new percussion sound due to the percussion sound is generated. In view of such characteristics of the percussion instrument, in a case where the key pressing operation does not correspond to the first operation (step S102: NO), the electronic musical instrument 1 determines whether the performance pattern is being played (step S104). In a case where the performance pattern is being played (step S104: YES), the electronic musical instrument 1 stops the performance pattern being played (step S105) in order to preferentially produce a new percussion sound corresponding to the key pressing operation, and proceeds to the processing of step S106. In a case where the performance pattern is not being played (step S104: NO), the electronic musical instrument 1 proceeds to the processing of step S106 without performing the processing of step S105 since there is no target to be stopped.

The electronic musical instrument 1 determines whether the key pressing operation corresponds to the second operation (step S106). The second operation is, for example, a key pressing operation performed for the second time after the drum performance function is turned on. In a case where the key pressing operation corresponds to the second operation (step S106: YES), the electronic musical instrument 1 updates the BPM of the performance pattern (step S107). Specifically, as described in the example of FIG. 4, the electronic musical instrument 1 calculates and updates the BPM on the basis of the time interval TI between the timing of the first operation and the timing of the second operation. The electronic musical instrument 1 plays the musical sound of the performance pattern corresponding to the key pressing operation with the BPM after the update (step S108).

The time required to calculate the BPM is significantly shorter than the time required to play the musical sound of the performance pattern after the key pressing operation is detected. Therefore, in step S108, the electronic musical instrument 1 can play the musical sound of the performance pattern corresponding to the second operation with the BPM after the update.

Thereafter, the musical sound of the performance pattern is played with the BPM updated in step S107. That is, when the key pressing operation is a third or subsequent key pressing operation (step S106: NO), the electronic musical instrument 1 plays the musical sound of the performance pattern corresponding to the key pressing operation without updating the BPM (step S108).

Even a user or a beginner who is not accustomed to performing a musical instrument can reproduce drum performances of various phrases with only one or two fingers as long as the user or the beginner taps four times on a beat, for example. By performing the key pressing operation in accordance with the melody, the tempo of the performance pattern becomes an appropriate tempo matching the melody. Since it is not necessary to set an appropriate tempo in advance, even a user who is unfamiliar with parameter setting operation or the like can enjoy drum performance harmonized with a melody.

The timing at which the tempo of the performance pattern is set is not limited to the timing exemplified in the flowchart of FIG. 5. The electronic musical instrument 1 may set the tempo of the performance pattern on the basis of the time interval between the timing of an n-th (n is a natural number of two or more) key pressing operation and the timing of an m-th (m is a natural number of three or more) key pressing operation. The n-th and m-th times may be discontinuous (for example, the first time, the third time, the second time, the fifth time, and the like).

The electronic musical instrument 1 may set the tempo of the performance pattern on the basis of the timings of three or more key pressing operations. For example, the electronic musical instrument 1 sets the tempo of the performance pattern on the basis of an average value of a plurality of time intervals (for example, a time interval between the timing of the first operation and the timing of the second operation and a time interval between the timing of the second operation and the timing of a third operation (key pressing operation subsequent to the second operation)). In this case, the tempo of the performance pattern can be set by more accurately reflecting the operation tempo.

The electronic musical instrument 1 may monitor the timing of the key pressing operation and update the tempo of the performance pattern as needed on the basis of the monitoring result. For example, every time the electronic musical instrument 1 detects a key pressing operation, the electronic musical instrument 1 measures a time interval from a previous key pressing operation (for example, one operation before or two operation before), and updates the tempo of the performance pattern to a tempo corresponding to the measured time interval. For example, every time a predetermined time (for example, several seconds) elapses, the electronic musical instrument 1 calculates an average value of the timing of the key pressing operation within the predetermined time, and updates the tempo of the performance pattern on the basis of the calculated average value.

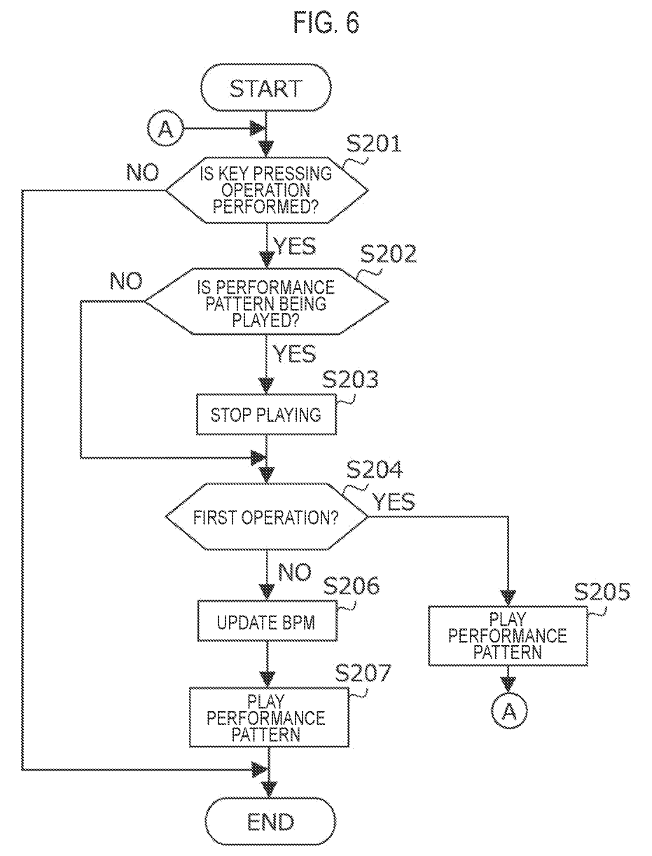

The tempo of the performance pattern may be changed during performance. Processing of changing the tempo of the performance pattern according to a first modification will be described with reference to FIG. 6. For example, when the user performs a predetermined tempo change operation for changing the tempo on the switch panel 15, execution of the processing illustrated in FIG. 6 is started.

The electronic musical instrument 1 determines whether the key pressing operation has been performed (step S201). For example, when the key pressing operation is not performed within a certain period of time after the tempo change operation (step S201: NO), the electronic musical instrument 1 ends the processing of this flowchart. That is, the tempo change operation is automatically canceled.

In a case where the key pressing operation has been performed within the certain period of time (step S201: YES), if the performance pattern is playing, the electronic musical instrument 1 stops the playing of the performance pattern (steps S202 to S203) as in steps S104 to S105 in FIG. 5. Next, the electronic musical instrument 1 determines whether the key pressing operation corresponds to the first operation (step S204). In the first modification, the first operation is, for example, a key pressing operation performed for the first time after the tempo change operation is performed.

In a case where the key pressing operation corresponds to the first operation (step S204: YES), the electronic musical instrument 1 plays the musical sound of the performance pattern corresponding to the key pressing operation without changing the current BPM (step S205), and returns to the processing of step S201.

When the key pressing operation does not correspond to the first operation (step S204: NO), this key pressing operation corresponds to the second operation. In the first modification, the second operation is, for example, a key pressing operation performed for the second time after the tempo change operation is performed. In this case, the electronic musical instrument 1 updates the BPM of the performance pattern (step S206). Specifically, the electronic musical instrument 1 calculates and updates the BPM on the basis of the time interval between the timing of the first operation and the timing of the second operation. The electronic musical instrument 1 plays the musical sound of the performance pattern corresponding to the key pressing operation with the BPM after the update (step S207) and ends the processing of this flowchart.

In this manner, in the first modification, the user can change the tempo of the performance pattern at any timing. In another modification, the electronic musical instrument 1 may sequentially change the tempo of the performance pattern in real time. Exemplarily, the electronic musical instrument 1 periodically acquires a time interval between two successive key pressing operations, and periodically updates the tempo of the performance pattern on the basis of the acquired time interval. Since the operation tempo is reflected as the tempo of the performance pattern, the user's intention is further reflected in the drum performance.

The tempo of the performance pattern cannot be set only at the timing of one key pressing operation. Therefore, in the above embodiment, the musical sound of the performance pattern corresponding to the first key pressing operation is played at the default tempo. In other words, the tempo is set immediately after the start of drum performance regardless of the user's operation.

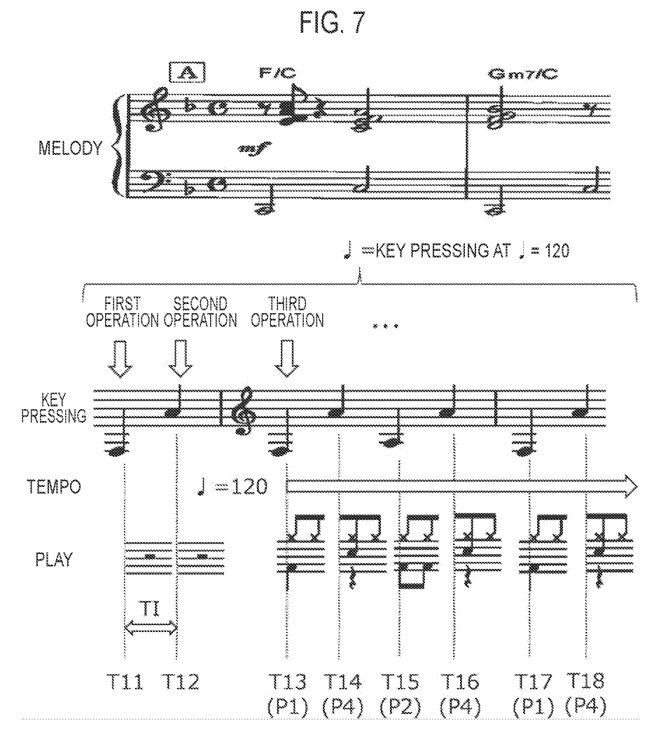

Therefore, in a second modification illustrated in FIG. 7, the electronic musical instrument 1 does not play a musical sound of a performance pattern corresponding to the first operation and the second operation. In the second modification, the electronic musical instrument 1 plays the musical sound of the performance pattern in accordance with the key pressing operation (the key pressing operation of the third operation or a subsequent operation after the second operation) after the tempo is set on the basis of the time interval TI. That is, in the second modification, the tempo is set on the basis of the operation tempo (for example, 120) of the user, and then the musical sound of the performance pattern is started to be played. It is possible to prevent the performance pattern from being played at a tempo that does not reflect the operation tempo.

The above description is a description of the exemplary embodiment of the present disclosure. The embodiment of the present disclosure is not limited to that described above, and various modifications can be made within the scope of the technical idea of the present disclosure. For example, the embodiment of the present application also includes contents obtained by appropriately combining the embodiment and the like exemplarily specified in the specification or obvious embodiments and the like.

What is claimed is:

1. An information processing apparatus comprising:
at least one performance operation element to which a performance pattern among a
plurality of performance operation elements is assigned; and
at least one processor, wherein
the at least one processor:
sets a tempo of the performance pattern on a basis of a timing of a plurality of
operations on the performance operation element, and
plays a musical sound of the performance pattern at the tempo having been set.

2. The information processing apparatus according to claim 1, wherein
the at least one processor sets the tempo on a basis of a time interval between a timing
of a first operation on the performance operation element and a timing of a second operation
after the first operation.

3. The information processing apparatus according to claim 2, wherein
the at least one processor does not play the musical sound of the performance pattern
corresponding to the first operation and the second operation, and plays the musical sound of
the performance pattern corresponding to an operation of at lease one operation after the
second operation at the tempo having been set.

4. The information processing apparatus according to claim 1, wherein
the performance pattern includes at least one musical sound and has a length of one or
more beats.

5. The information processing apparatus according to claim 1, wherein
a predetermined phrase is divided into a plurality of sections, and at least one musical
sound proceeding in each of the sections divided forms the performance pattern.

6. The information processing apparatus according to claim 1, wherein
the performance pattern includes a plurality of timbres.

7. The information processing apparatus according to claim 1, wherein
the timbre of the musical sound is a percussion instrument.

8. An electronic musical instrument comprising:
a plurality of the performance operation elements to which a performance pattern being
different is assigned; and
the information processing apparatus according to claim 1.

9. The electronic musical instrument according to claim 8, wherein
the performance operation element includes a white key and a black key.

10. The electronic musical instrument according to claim 8, further comprising:
a first mode in which only one timbre sounds for each performance operation element;
and
a second mode in which a timbre which is different from the timbre of the first mode
sounds as the performance pattern.

11. A method of causing a computer to execute processing of:
setting a tempo of a performance pattern on a basis of a timing of a plurality of
operations on a performance operation element to which the performance pattern is assigned;
and
playing a musical sound of the performance pattern at the tempo having been set.

12. A non-transitory computer-readable recording medium recording a program that causes a
computer to execute processing of:
setting a tempo of a performance pattern on a basis of a timing of a plurality of
operations on a performance operation element to which the performance pattern is assigned;
and
playing a musical sound of the performance pattern at the tempo having been set.
